(19) United States
(12) Patent Application Publication
(10) Pub. No.: US 2016/0084365 A1
(43) Pub. Date: Mar. 24, 2016

(54) DIFFERENTIAL HOUSING COVER AND ASSEMBLY

(71) Applicant: Eaton Corporation, Cleveland, OH (US)

(72) Inventors: Scott M. Besemer, Battle Creek, MI (US); Daniel P. Fisher, Coldwater, MI (US); Andrew N. Edler, Homer, MI (US); Gregory L. Heatwole, Marshall, MI (US)

(21) Appl. No.: 14/957,944

(22) Filed: Dec. 3, 2015

Related U.S. Application Data
(63) Continuation of application No. PCT/US2014/040494, filed on Jun. 2, 2014.
(60) Provisional application No. 61/831,584, filed on Jun. 5, 2013.
(60) Provisional application No. 62/006,321, filed on Jun. 2, 2014.

(51) Int. Cl. F16H 48/22; F16H 57/031; F16H 48/32; F16H 57/037

(52) U.S. Cl. CPC F16H 48/22; F16H 57/037; F16H 57/031; F16H 48/32

(57) ABSTRACT

A cover for a differential housing is disclosed herein. The cover can include a body, a flange, a fluid reservoir, a first fluid conduit, and second fluid conduit. The body can have an inwardly-facing surface and outwardly-facing surface opposite the inwardly-facing surface. The flange can extend about at least a portion of a perimeter of the body. The fluid reservoir can be defined within the body and have a reservoir outlet and a return port. The first fluid conduit can be defined within the body. The first fluid conduit can be spaced from the fluid reservoir and extend between a first inlet and a first outlet. The second fluid conduit can be defined within the body and extend between the first fluid conduit and the return port of the fluid reservoir.

### CROSS-REFERENCE TO RELATED APPLICATIONS

This application is a continuation of International Patent Application No. PCT/US2014/040494 filed on Jun. 2, 2014, which claims the benefit of U.S. Patent Application No. 61/831,584 filed on Jun. 5, 2013 and U.S. Patent Application No. 62/006,321 filed on Jun. 2, 2014. The disclosures of the above applications are incorporated herein by reference.

### FIELD

The present disclosure relates generally to differential assemblies and, more particularly, to a hydraulic power supply configuration on a rear wheel drive electronic limited slip differential.

### BACKGROUND

Differentials are provided on vehicles to permit an outer drive wheel to rotate faster than an inner drive wheel during cornering as both drive wheels continue to receive power from the engine. While differentials are useful in cornering, they can allow vehicles to lose traction, for example, in snow or mud or other slick mediums. If either of the drive wheels loses traction, it will spin at a high rate of speed and the other wheel may not spin at all. To overcome this situation, limited-slip differentials were developed to shift power from the drive wheel that has lost traction and is spinning, to the drive wheel that is not spinning.

Electronically-controlled, limited-slip differentials can include a hydraulically-actuated clutch to limit differential rotation between output shafts of the differential. The hydraulically-actuated clutch, however, must be powered by a separate pump. In addition to the extra cost associated with providing a separate pump as described, such pumps can introduce parasitic energy losses that can negatively impact vehicle fuel economy and vehicle operation. For at least these reasons, an improved differential is desired.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A cover for a differential housing can include a body, a flange, a fluid reservoir, a first fluid conduit, and second fluid conduit. The body can have an inwardly-facing surface and outwardly-facing surface opposite the inwardly-facing surface. The flange can extend about at least a portion of a perimeter of the body. The fluid reservoir can be defined within the body and have a reservoir outlet and a return port. The first fluid conduit can be defined within the body. The first fluid conduit can be spaced from the fluid reservoir and extend between a first inlet and a first outlet. The second fluid conduit can be defined within the body and extend between the first fluid conduit and the return port of the fluid reservoir.

According to other features, the cover can include a three-way valve positioned at an intersection of the first fluid conduit and the second fluid conduit. The three-way valve can be operable in a first setting and a second setting. In the first setting, fluid passage between the first inlet and the first outlet can be permitted and fluid passage along the second fluid conduit can be prevented. In the second setting, fluid passage between the first inlet and the first outlet can be prevented and fluid passage along the second fluid conduit can be permitted.

In other features, a bleed orifice can be positioned at an intersection of the first fluid conduit and the second fluid conduit. The bleed orifice can permit continuous fluid passage from the first fluid conduit to the second fluid conduit. A diameter of the bleed orifice can be between ten and twelve percent of a diameter of the first fluid conduit. The second fluid conduit can include a portion of increasing diameter extending from the bleed orifice and the intersection with the first fluid conduit. The second fluid conduit can extend vertically from the bleed orifice and the intersection with the first fluid conduit. The second fluid conduit can include a first portion extending vertically upward from the bleed orifice and the intersection with the first fluid conduit, a second portion extending horizontally from the first portion, and a third portion extending vertically downward from the second portion to the return port of the fluid reservoir.

According to additional features, the cover can include a secondary return port and a third fluid conduit. The secondary return port can be formed in the fluid reservoir spaced from the return port. The third fluid conduit can be defined within the body and extend between the first fluid conduit and the secondary return port in the fluid reservoir.

According to other features, the reservoir outlet can be positioned on the outwardly-facing surface of the body and the first outlet can be positioned on the inwardly-facing surface of the body. The first inlet can be positioned on the outwardly-facing surface of the body. The return port can be positioned internally with respect to the body, spaced from both the outwardly-facing surface and the inwardly-facing surface.

A cover assembly for a differential housing can include a body, a flange, a fluid reservoir, a first fluid conduit, a fluid pump, and a second fluid conduit. The body can have an inwardly-facing surface and an outwardly-facing surface opposite the inwardly-facing surface. The flange can extend about at least a portion of a perimeter of the body. The fluid reservoir can be defined within the body and have a reservoir outlet and a return port. The first fluid conduit can be defined within the body, spaced from the fluid reservoir, and extend between a first inlet and a first outlet. The fluid pump can have a pump inlet fluidly coupled to the reservoir outlet and a pump outlet fluidly coupled to the first inlet. The fluid pump can be mounted on the body and be operable to draw fluid from the fluid reservoir and direct the fluid into the first inlet. The second fluid conduit can be defined within the body and extend between the first fluid conduit and the return port of the fluid reservoir.

In other features, a motor can be mounted on the body and be operably positioned to power the fluid pump. A third fluid conduit can be defined within the body, spaced from the fluid reservoir, and extend from one of the first fluid conduit and the second fluid conduit to a third outlet. A fluid pressure sensor can cap the third outlet of the third fluid conduit. The third fluid conduit can extend from the first fluid conduit and be spaced from the second fluid conduit.

According to additional features, the cover assembly can include a secondary return port, a third fluid conduit, and a pressure relief valve. The secondary return port can be formed in the fluid reservoir and be spaced from the return port. The third fluid conduit can be defined within the body and extend between the first fluid conduit and the secondary return port in the fluid reservoir. The pressure relief valve can be positioned along the third fluid conduit and be proximate to the fluid reservoir.

A differential assembly can include a housing, a differential subassembly, and a cover assembly. The housing can include a first flange and can define a cavity. The differential subassembly can be positioned in the cavity of the housing. The differential subassembly can include a case, a plurality of pinion gears engaged for movement with the case, a plurality of side gears engaged with the plurality of pinion gears, a clutch pack operable to selectively interlock the case and one of the plurality of side gears, and a piston assembly positioned to act on the clutch pack and urge the clutch pack into a locking configuration. The piston assembly can include a plenum having a plenum inlet operable to receive pressurized fluid. The cover assembly can be removably engageable with the housing to selectively enclose the differential subassembly within the housing. The cover assembly can include a body having an inwardly-facing surface and outwardly-facing surface opposite the inwardly-facing surface. The cover assembly can also include a second flange extending about at least a portion of a perimeter of the body and engageable with the first flange of the housing. The cover assembly can also include a fluid reservoir defined within the body and having a reservoir outlet and a return port. The cover assembly can also include a first fluid conduit defined within the body, spaced from the fluid reservoir, and extending between a first inlet and a first outlet. The first outlet can be coupled to the plenum inlet. The cover assembly can also include a fluid pump having a pump inlet fluidly coupled to the reservoir outlet and a pump outlet fluidly coupled to the first inlet. The fluid pump can be mounted on the body and can be operable to draw fluid from the fluid reservoir and direct the fluid into the first inlet. The cover assembly can also include a second fluid conduit defined within the body and extending between the first fluid conduit and the return port of the fluid reservoir.

According to other features, the first outlet can be defined on the inwardly-facing surface of the body and the plenum can seal directly against the inwardly-facing surface. The differential assembly can also include a sealing member positioned between the inwardly-facing surface of the body and the plenum inlet. The differential assembly can also include at least one of a bleed orifice and a three-way valve positioned to limit fluid flow between the first fluid conduit and the second fluid conduit.

### BRIEF DESCRIPTION OF THE DRAWINGS

The present disclosure will become more fully understood from the detailed description and the accompanying drawings, wherein:

FIG. 1 is a generally front perspective view of a differential assembly constructed in accordance with one example of the present disclosure;

FIG. 2 is another general front perspective view of the differential assembly shown in FIG. 1 with a cover assembly removed;

FIG. 3 is a generally rear perspective view of the differential assembly shown in FIG. 1 with a housing removed;

FIG. 4 is a front view of the cover assembly of the differential assembly shown in FIG. 1;

FIG. 5 is a generally rear perspective view of the cover assembly shown in FIG. 4 and a piston assembly;

FIG. 6 is a generally rear perspective view of the cover assembly shown in FIGS. 4 and 5;

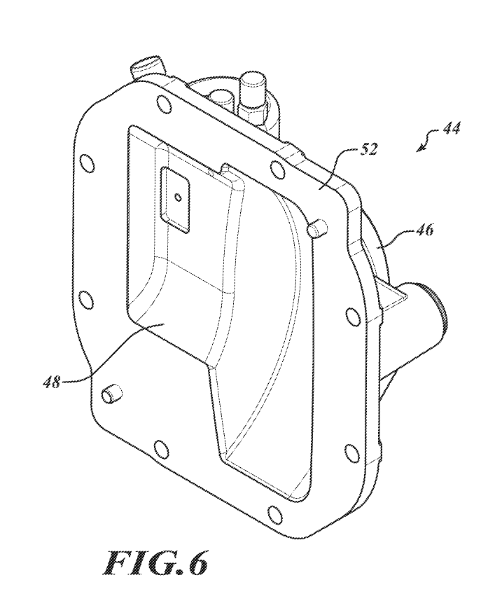

FIG. 7 is a generally front perspective view of the piston assembly shown in FIG. 5;

FIG. 8 is a perspective view of a portion of the cover assembly shown in FIGS. 4-6, wherein an internal fluid circuit is shown in phantom;

FIG. 9 is a cross-sectional view of a portion of the cover assembly shown in FIGS. 4-6 and 8, wherein the section is taken along section lines 9-9 in FIG. 4;

FIG. 10 is a cross-sectional view of a portion of the cover assembly shown in FIGS. 4-6 and 8, wherein the section is taken along section lines 10-10 in FIG. 9;

FIG. 11 is a cross-sectional view of a portion of the cover assembly shown in FIGS. 4-6 and 8, wherein the section is taken along section lines 11-11 in FIG. 10;

FIG. 12 is a cross-sectional view of a portion of the cover assembly shown in FIGS. 4-6 and 8, wherein the section is taken along section lines 12-12 in FIG. 11;

FIG. 13 is an isometric cross-section of a bleed orifice;

FIG. 14 is a generally front perspective view of a differential assembly constructed in accordance with one example of the present disclosure, showing several internal structures in phantom; and

FIG. 15 is an enlarged portion of FIG. 14 with some structures omitted to enhance the clarity of internal fluid passageways shown in phantom.

### DETAILED DESCRIPTION

A plurality of different embodiments of the disclosure is shown in the Figures of the application. Similar features are shown in the various embodiments of the disclosure. Similar features have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

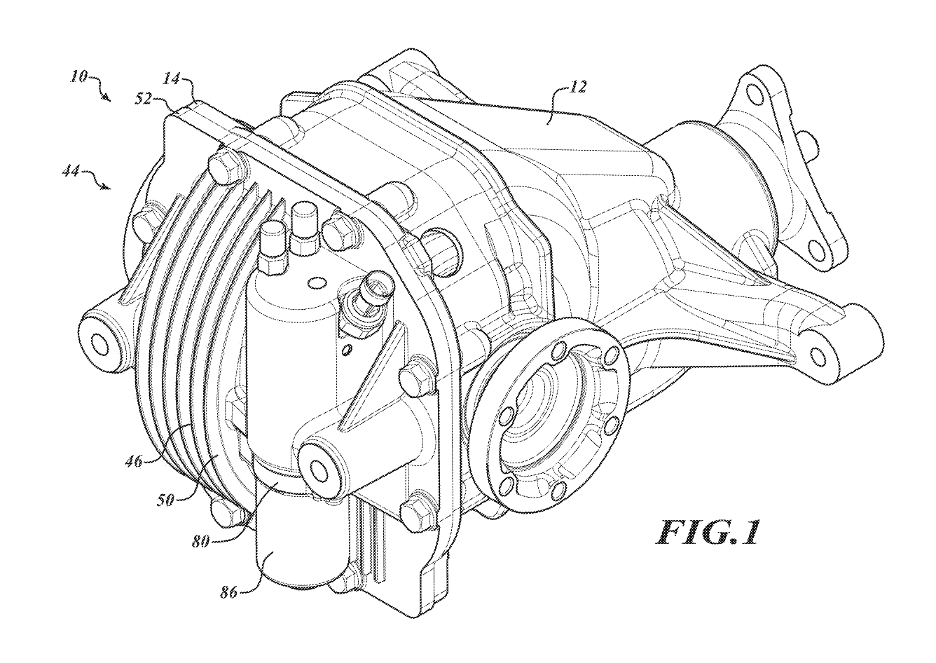

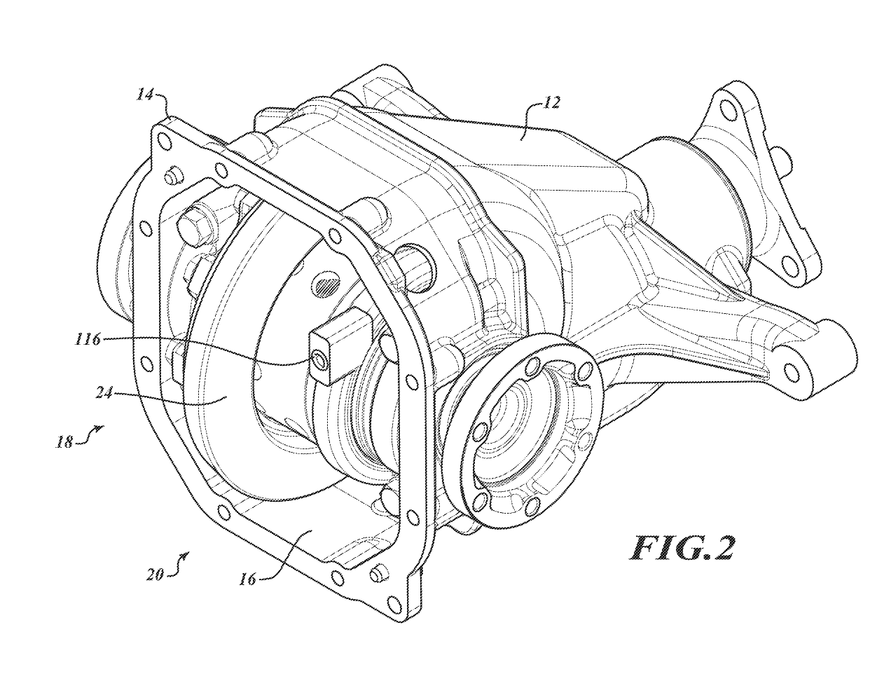

FIG. 1 is a generally front perspective view of a differential assembly 10 constructed in accordance with one example of the present disclosure. The differential assembly 10 includes a housing 12. The housing 12 includes a first flange 14. The housing 12 defines a cavity 16, as best shown in FIG. 2.

The differential assembly 10 also includes a differential subassembly 18 positioned in the cavity 16. The differential subassembly 18 includes a case 20 enclosing a plurality of gears, described in greater detail below. The case 20 can include left-hand and right-hand portions coupled together.

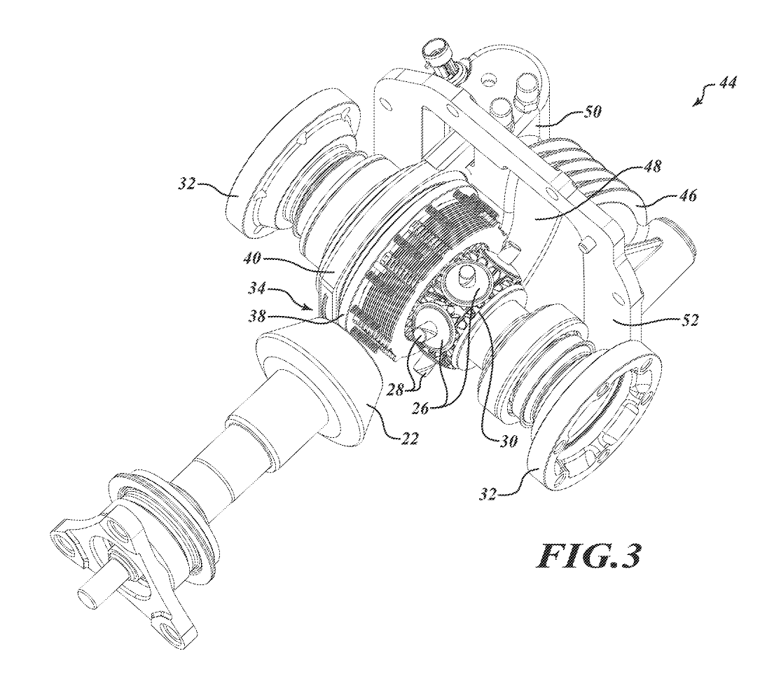

The differential subassembly 18 can transmit rotary power from the vehicle engine to wheels of the vehicle. For example, rotary power is received by the differential subassembly 18 from the vehicle engine through a pinion gear 22, shown in FIG. 3. The pinion gear 22 is meshed with and drives a ring gear 24, shown in FIG. 2, in rotation. The ring gear 24 is fixed for rotation with the case 20.

As set forth above, a plurality of gears are enclosed in the case 20. The differential subassembly 18 includes pinion gears 26, as shown in FIG. 3. The pinion gears 26 are mounted for rotation on shafts 28. The shafts 28 are fixed for rotation with the case 20. The differential subassembly 18 also includes side gears 30. The side gears 30 are meshed with the plurality of pinion gears 26. The side gears 30 are also engaged with axle assemblies 32 through splines. The gears 26 and 30 cooperate to differentially distribute rotary power between the axle assemblies 32.

The differential subassembly 18 also includes a clutch pack 34 operable to selectively interlock the case 20 and one of the plurality of side gears 30. The clutch pack 34 includes alternating metallic plates and friction material plates. Some of the plates are fixed for rotation with one of the side gears 30, while other plates are fixed for rotation with the case 20. When the clutch pack 34 is engaged, or in a locking configuration, the plates are pressed together. Further, the case 20 and the side gear 30 become fixed for rotation together. When the clutch pack 34 is disengaged, or in a released configuration, the plates are not pressed together and the case 20 and the side gear 30 are rotatable relative to each other.

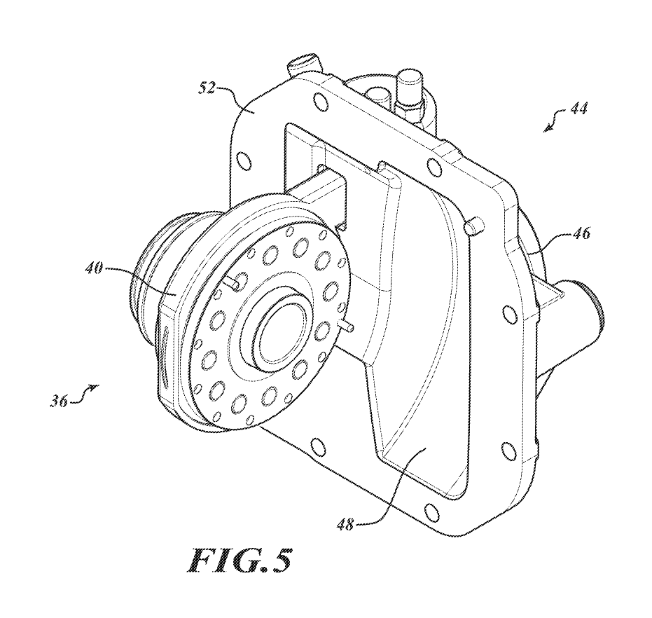

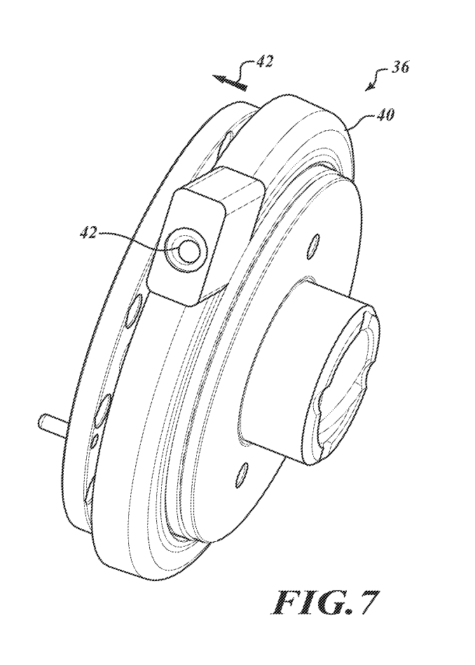

The differential subassembly 18 also includes a piston assembly 36 operable to control the clutch pack 34. The piston assembly 36 is shown in FIGS. 5 and 7. The piston assembly 36 acts on the clutch pack 34 and urges the clutch pack 34 into the locking configuration. The piston assembly 36 also includes a plenum 40. The plenum 40 has a plenum inlet 42 operable to receive pressurized fluid for urging the clutch pack 34 into the locking configuration. In response to pressurized fluid, a portion of the piston assembly 36 can move relative to the plenum 40 in the direction referenced at 42 in FIG. 7.

The differential assembly 10 also includes a cover assembly 44 removably engageable with the housing 12 to selectively enclose the differential subassembly 18 within the housing 12. The cover assembly 44 includes a body 46 having an inwardly-facing surface 48 and an outwardly-facing surface 50 opposite the inwardly-facing surface 48. The cover assembly 44 includes a second flange 52 extending around at least a portion of a perimeter of the body 46. The second flange 52 is engageable with the first flange 14 of the housing 12. Fasteners can pass through aligned apertures in the flanges 14, 52 to interconnect the housing 12 and the cover assembly 44.

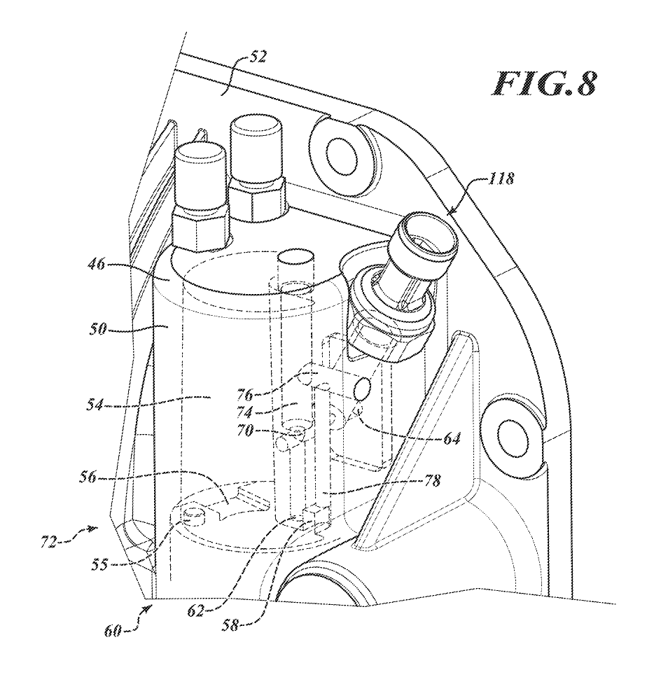

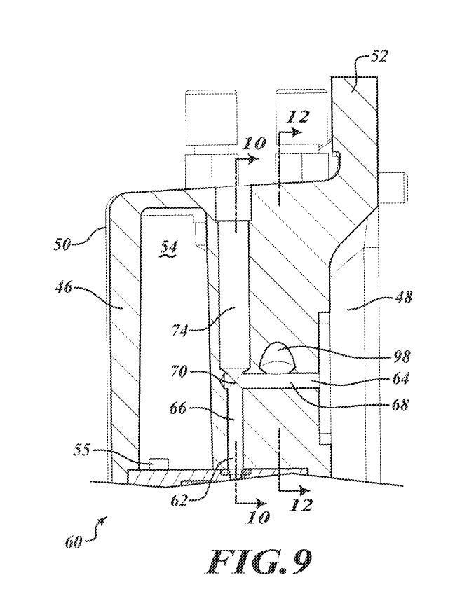

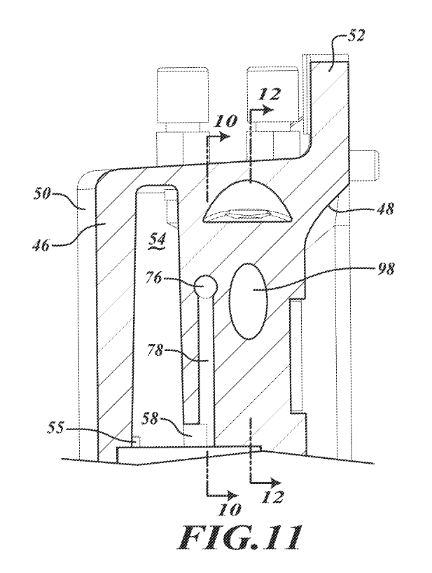

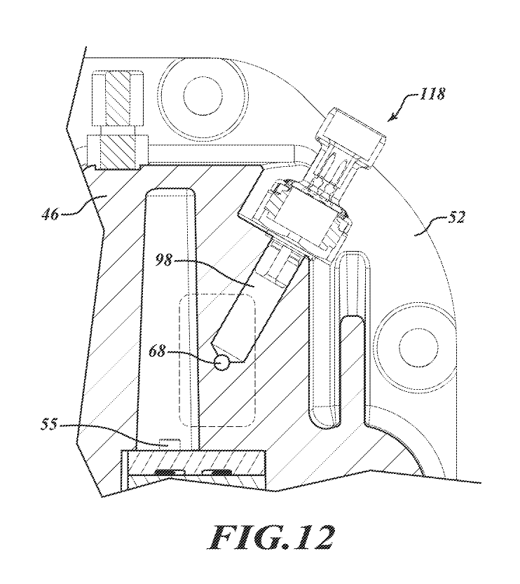

An internal fluid circuit is formed in the body 46. As best shown in FIGS. 8-12, the internal fluid circuit includes a fluid reservoir 54 defined within the body 46. The fluid reservoir 54 includes a reservoir outlet 56 and a return port 58. The reservoir outlet 56 is positioned on the outwardly-facing surface 50 of the body 46. The return port 58 is positioned internally with respect to the body 46, spaced from both the outwardly-facing surface 50 and the inwardly-facing surface 48. The first outlet 64 is defined on the inwardly-facing surface 48 of the body 46, and the plenum 40 can seal directly against the inwardly-facing surface 48. For example, a sealing member such as an o-ring 116 can be positioned between the inwardly-facing surface 48 of the body 46 and the plenum inlet 42.

The internal fluid circuit also includes a first fluid conduit 60 defined within the body 46. The first fluid conduit 60 is spaced from the fluid reservoir 54. The first fluid conduit 60 extends between a first inlet 62 and a first outlet 64. The first inlet 62 is positioned on the outwardly-facing surface 50 of the body 46. The first outlet 64 is positioned on the inwardly-facing surface 48 of the body 46 and is coupled to the plenum inlet 42. The exemplary first fluid conduit 60 includes a first portion 66 extending vertically upward from the first fluid inlet 62 and a second portion 68 extending horizontally from the first fluid outlet 64. The first portion 66 and the second portion 68 intersect at a position 70 along the first fluid conduit 60.

The internal fluid circuit also includes a second fluid conduit 72 defined within the body 46. The second fluid conduit 72 extends between the first fluid conduit 60 and the return port 58 of the fluid reservoir 54. The exemplary second fluid conduit 72 includes a first portion 74 extending vertically upward from the position 70. The exemplary second fluid conduit 72 also includes a second portion 76 extending horizontally from the first portion 74. The exemplary second fluid conduit 72 also includes a third portion 78 extending vertically downward from the second portion 76 to the return port 58 of the fluid reservoir 54.

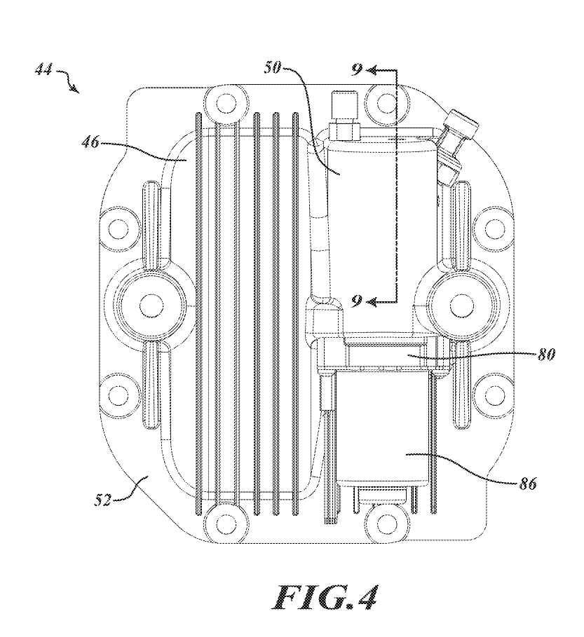

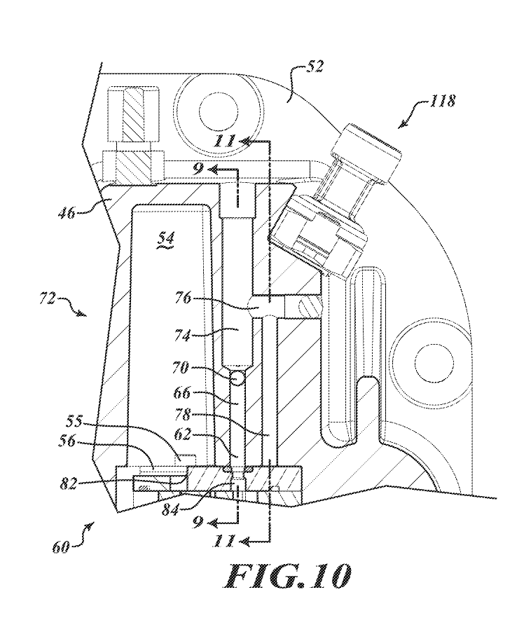

As best shown in FIGS. 1 and 4, the exemplary cover assembly 44 can include a fluid pump 80. The fluid pump 80 can be a gerotor pump. The fluid pump 80 can have a pump inlet 82 (shown in FIG. 10) fluidly coupled to the reservoir outlet 56. The fluid pump 80 can also have a pump outlet 84 (shown in FIG. 10) fluidly coupled to the first inlet 62. The fluid pump 80 can be mounted on the body 46 and be operable to draw fluid from the fluid reservoir 54 and direct the fluid into the first inlet 62.

As best shown in FIGS. 1 and 4, the exemplary cover assembly 44 can also include a motor 86. One or more fasteners 55 connect the body 46 to the pump 80 and the motor 86. The motor 86 can be mounted on the body 46. The motor 86 can be operably positioned to power the fluid pump 80 for pumping fluid through the fluid circuit. The motor 86 can be an electric motor or can be powered differently.

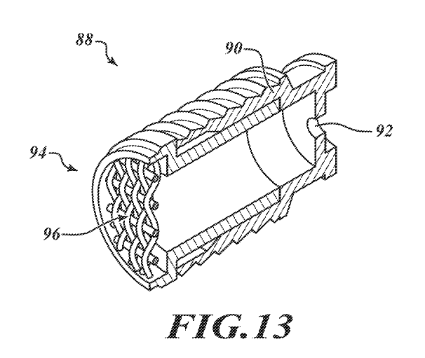

A bleed orifice can be positioned at the intersection of the first fluid conduit 60 and the second fluid conduit 72, the position 70. The bleed orifice is not shown in FIGS. 8-12 to enhance the clarity of the structure of the fluid circuit. An exemplary bleed orifice 88 is shown in FIG. 13. The exemplary bleed orifice 88 can limit fluid flow, but permit continuous fluid passage from the first fluid conduit 60 to the second fluid conduit 72. The exemplary bleed orifice 88 includes a tubular portion 90, necked-down to an orifice 92. A screen assembly 94 of the bleed orifice 88 is received in the tubular portion 90 and includes a screen 96. The exemplary bleed orifice 88 can be positioned such the screen 96 is proximate to the first fluid conduit 60 or proximate to the second fluid conduit 72.

In one exemplary operation, the motor 86 can drive the fluid pump 80 into pumping action when engagement of the clutch pack 34 is desired. The fluid pump 80 can draw fluid from the reservoir 54 through the reservoir outlet 56 and the pump inlet 82. The fluid pump 80 can direct pressurized fluid through the pump outlet 84 and the first inlet 62. Pressurized fluid can travel through the first portion 66 of the first fluid conduit 60 to the first position 70. As will be discussed further below, some of the pressurized fluid can be diverted through the bleed orifice 88. Most of the fluid will continue along the first fluid conduit 60, reaching the second portion 68. The pressurized fluid will pass out of the first fluid outlet 64 and into the plenum 40 of the piston assembly 36. The amount of fluid in the plenum 40 will increase, causing the piston 38 to extend out of the piston assembly 36 and compress the clutch pack 34.

In another exemplary operation, the motor 86 can be disengaged, disengaging the fluid pump 80 from pumping action, when engagement of the clutch pack 34 is not desired. When this occurs, fluid can escape the plenum 40 of the piston assembly 36 and be received in the second portion 68 of the first fluid conduit 60. In some embodiments, it is possible that some fluid may pass through the first fluid conduit 60 and the fluid pump 80 to return to the reservoir. The bleed orifice 88 and the second fluid conduit 72 define a passageway for fluid evacuating the plenum 40 to return to the reservoir 54. Fluid can pass through the orifice 92, the first portion 74, the second portion 76, the third portion 78, and the return port 58 of the fluid reservoir 54.

As set forth above, pressurized fluid can be diverted from reaching the plenum 40 by passing through the bleed orifice 88 instead. However, a diameter of the bleed orifice 88 can be significantly smaller than a diameter of the first fluid conduit 60, to reduce the extent or rate of diverted fluid. In one embodiment of the present disclosure, a diameter of the orifice 92 can be ten and twelve percent of a diameter of the first fluid conduit 60. Also, the screen 96 can provide resistance to fluid movement through the bleed orifice 88.

The configuration of the second fluid conduit 72 can also provide resistance to fluid movement through the bleed orifice 88. In the exemplary embodiment, the first portion 74 of the second fluid conduit 72 extends vertically from the position 70 and the bleed orifice 88, allowing gravity to be applied to resist fluid movement. Also, the first portion 74 has a greater diameter than the bleed orifice 88 and the intersection with the first fluid conduit 60. As a depth of fluid in the first portion 74 increases, static fluid pressure against fluid movement out of the bleed orifice 88 will increase.

The exemplary cover assembly 44 also includes a third fluid conduit 98 defined within the body 46. The third fluid conduit 98 can be spaced from the fluid reservoir 54 and extend from the first fluid conduit 60 or the second fluid conduit 72 to a third outlet. In the exemplary embodiment, the third fluid conduit 98 extends from the first fluid conduit 60 and is spaced from the second fluid conduit 72. A fluid pressure sensor 118 can cap the third outlet of the third fluid conduit 98. Data sensed by the pressure sensor 118 can be applied by a controller (not shown) to control the operation of the motor 86.

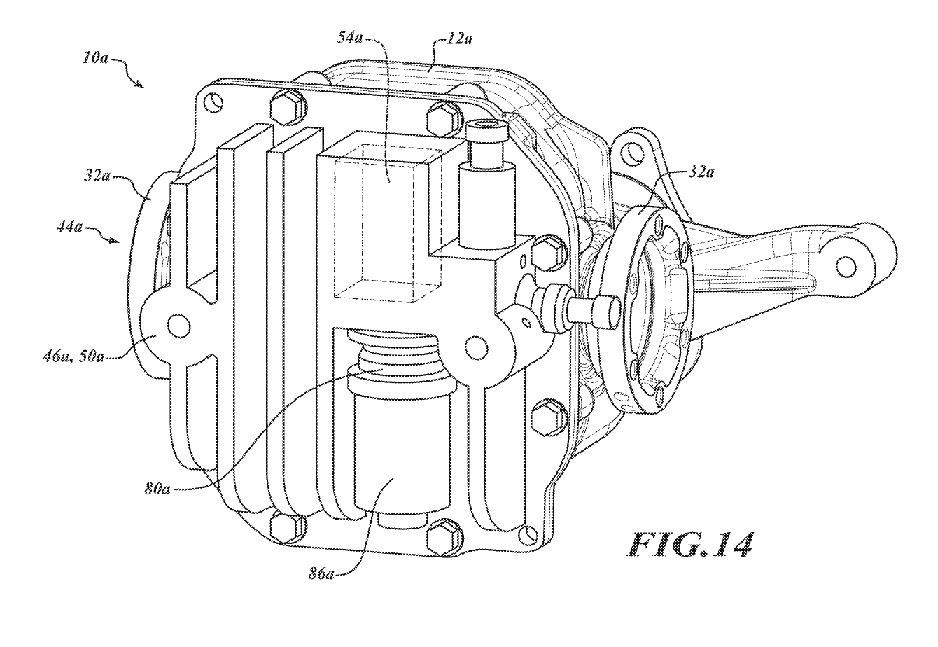

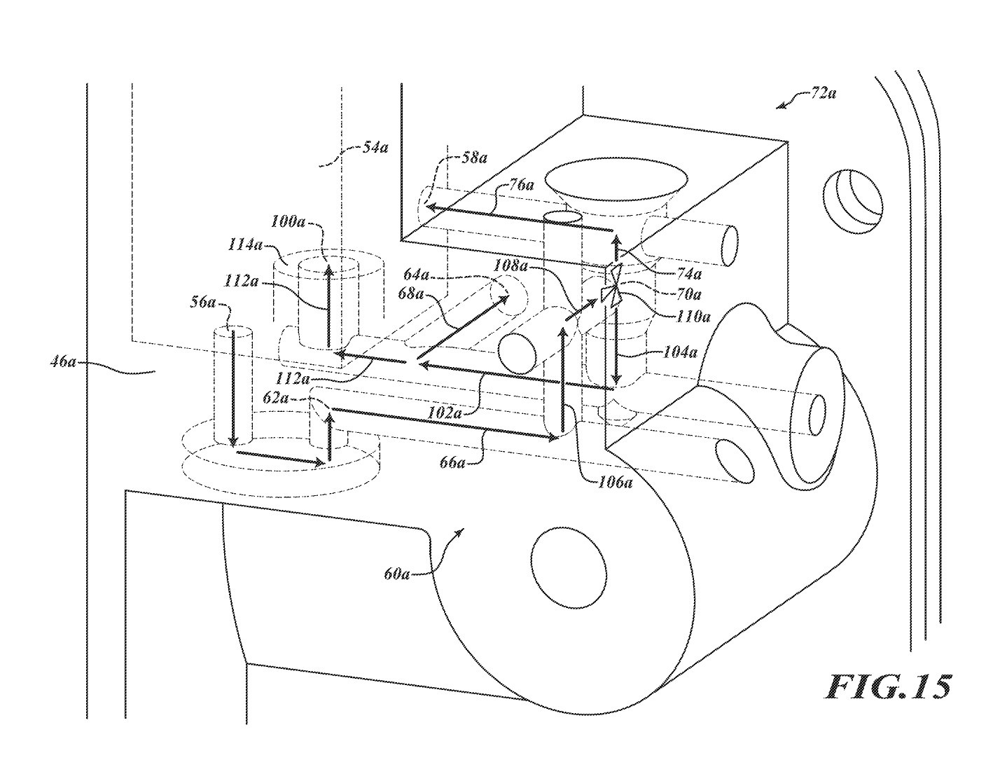

A second embodiment of the present disclosure is shown in FIGS. 14 and 15. FIG. 14 is a generally front perspective view of a differential assembly 10a including a housing 12a. The housing 12a can define a cavity and a differential subassembly positioned in the cavity. The differential subassembly can transmit rotary power from the vehicle engine to wheels of the vehicle through axle assemblies 32a. The differential subassembly can include a clutch pack and a piston assembly operable to control the clutch pack.

The differential assembly also includes a cover assembly 44a removably engageable with the housing 12a to selectively enclose the differential subassembly within the housing 12a. The cover assembly 44a includes a body 46a having an inwardly-facing surface (not visible) and outwardly-facing surface 50a opposite the inwardly-facing surface. An internal fluid circuit is formed in the body 46a. The exemplary cover assembly 44a can also include a fluid pump 80a and a motor 86a operably positioned to power the fluid pump 80a for pumping fluid through the fluid circuit.

As best shown in FIG. 15, the internal fluid circuit includes a fluid reservoir 54a defined within the body 46a. The fluid reservoir 54a includes a reservoir outlet 56a and return ports 58a and 100a. The internal fluid circuit also includes a first fluid conduit 60a defined within the body 46a. The first fluid conduit 60a is spaced from the fluid reservoir 54a. The first fluid conduit 60a extends between a first inlet 62a and a first outlet 64a. The first outlet 64a is coupled to a plenum inlet. The exemplary first fluid conduit 60a includes a plurality of portions represented by arrows in FIG. 15. A first portion 66a extends horizontally from the first fluid inlet 62a. A second portion 68a extends horizontally from the first fluid outlet 64a. A third portion 102a extends horizontally from and transverse to the second portion 68a. A fourth portion 104a extends vertically from the third portion 102a. A fifth portion 106a extends vertically from the first portion 66a. A sixth portion 108a extends horizontally from the fifth portion 106a.

The internal fluid circuit also includes a second fluid conduit 72a defined within the body 46a. The second fluid conduit 72a extends between the first fluid conduit 60a and the return port 58a of the fluid reservoir 54a. The exemplary second fluid conduit 72a includes a first portion 74a extending vertically upward and a second portion 76a extending horizontally from the first portion 74a to the return port 58a.

A three-way valve can be located at a position 70a, the point of intersection between the first and second fluid conduits 60a, 72a. The three-way valve limits fluid flow between the first and second fluid conduits 60a, 72a and is illustrated schematically at 110a. The three-way valve 110a is operable in a first setting and a second setting. In the first setting, the three-way valve 110a permits fluid passage between the first inlet 62a and the first outlet 64a. Fluid passage along the second fluid conduit 72a is prevented. The three-way valve 110a is configured in the first setting when fluid is being pumped to the clutch of the differential assembly. In the second setting, the three-way valve 110a prevents fluid passage between the first inlet 62a and the first outlet 64a. Fluid is diverted off the first fluid conduit 60a at the position 70a and diverted to the second fluid conduit 72a. The three-way valve 110a is configured in the second setting when the clutch is de-energized and fluid is flowing back to the reservoir 54a.

The second exemplary embodiment includes the secondary return port 100a formed in the fluid reservoir 54a spaced from the return port 58a. A third fluid conduit 112a is defined within the body 46a and extends between the first fluid conduit 60a and the secondary return port 100a of the fluid reservoir 54a. A pressure relief valve 114a can be positioned along the third fluid conduit 112a proximate to the fluid reservoir 54a. The pressure relief valve 114a can open in response to excessive pressure in the first fluid conduit 60a.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cover for a differential housing comprising:
a body having an inwardly-facing surface and an outwardly-facing surface opposite the inwardly-facing surface;
a flange extending about at least a portion of a perimeter of the body;
a fluid reservoir defined within the body and having a reservoir outlet and a return port;
a first fluid conduit defined within the body, spaced from the fluid reservoir, and extending between a first inlet and a first outlet; and
a second fluid conduit defined within the body and extending between the first fluid conduit and the return port of the fluid reservoir.

2. The cover of claim 1 further comprising:
a three-way valve positioned at an intersection of the first fluid conduit and the second fluid conduit, the three-way valve operable in a first setting and a second setting, in the first setting fluid passage between the first inlet and the first outlet being permitted and fluid passage along the second fluid conduit being prevented, and in the second setting fluid passage between the first inlet and the first outlet being prevented and fluid passage along the second fluid conduit being permitted.

3. The cover of claim 1 further comprising:
a bleed orifice positioned at an intersection of the first fluid conduit and the second fluid conduit, the bleed orifice permitting continuous fluid passage from the first fluid conduit to the second fluid conduit.

4. The cover of claim 3 wherein a diameter of the bleed orifice is between ten and twelve percent of a diameter of the first fluid conduit.

5. The cover of claim 3 wherein the second fluid conduit includes a portion of increasing diameter extending from the bleed orifice and the intersection with the first fluid conduit.

6. The cover of claim 3 wherein the second fluid conduit extends vertically from the bleed orifice and the intersection with the first fluid conduit.

7. The cover of claim 6 wherein the second fluid conduit includes a first portion extending vertically upward from the bleed orifice and the intersection with the first fluid conduit, a second portion extending horizontally from the first portion, and a third portion extending vertically downward from the second portion to the return port of the fluid reservoir.

8. The cover of claim 1 further comprising:
a secondary return port formed in the fluid reservoir spaced from the return port; and
a third fluid conduit defined within the body and extending between the first fluid conduit and the secondary return port in the fluid reservoir.

9. The cover of claim 1 wherein the reservoir outlet is positioned on the outwardly-facing surface of the body and the first outlet is positioned on the inwardly-facing surface of the body.

10. The cover of claim 9 wherein the first inlet is positioned on the outwardly-facing surface of the body.

11. The cover of claim 10 wherein the return port is positioned internally with respect to the body, spaced from both the outwardly-facing surface and the inwardly-facing surface.

12. A cover assembly for a differential housing comprising:
a body having an inwardly-facing surface and an outwardly-facing surface opposite the inwardly-facing surface;
a flange extending about at least a portion of a perimeter of the body;
a fluid reservoir defined within the body and having a reservoir outlet and a return port;
a first fluid conduit defined within the body, spaced from the fluid reservoir, and extending between a first inlet and a first outlet;
a fluid pump having a pump inlet fluidly coupled to the reservoir outlet and a pump outlet fluidly coupled to the first inlet, the fluid pump mounted on the body and operable to draw fluid from the fluid reservoir and direct the fluid into the first inlet; and
a second fluid conduit defined within the body and extending between the first fluid conduit and the return port of the fluid reservoir.

13. The cover assembly of claim 12 further comprising:
a motor mounted on the body and operably positioned to power the fluid pump.

14. The cover assembly of claim 12 further comprising:
a third fluid conduit defined within the body, spaced from the fluid reservoir, and extending from one of the first fluid conduit and the second fluid conduit to a third outlet; and
a fluid pressure sensor capping the third outlet of the third fluid conduit.

15. The cover assembly of claim 14 wherein the third fluid conduit extends from the first fluid conduit and is spaced from the second fluid conduit.

16. The cover assembly of claim 12 further comprising:
a secondary return port formed in the fluid reservoir spaced from the return port;
a third fluid conduit defined within the body and extending between the first fluid conduit and the secondary return port in the fluid reservoir; and
a pressure relief valve positioned along the third fluid conduit proximate to the fluid reservoir.

17. A differential assembly comprising:
a housing including a first flange and defining a cavity;
a differential subassembly positioned in the cavity of the housing and including a case, a plurality of pinion gears engaged for movement with the case, a plurality of side gears engaged with the plurality of pinion gears, a clutch pack operable to selectively interlock the case and one of the plurality of side gears, and a piston assembly positioned to act on the clutch pack and urge the clutch pack into a locking configuration, wherein the piston assembly also includes a plenum having a plenum inlet operable to receive pressurized fluid; and
a cover assembly removably engageable with the housing to selectively enclose the differential subassembly within the housing, the cover assembly including:
a body having an inwardly-facing surface and outwardly-facing surface opposite the inwardly-facing surface,
a second flange extending about at least a portion of a perimeter of the body and engageable with the first flange of the housing,
a fluid reservoir defined within the body and having a reservoir outlet and a return port;
a first fluid conduit defined within the body, spaced from the fluid reservoir, and extending between a first inlet and a first outlet, wherein the first outlet is coupled to the plenum inlet,
a fluid pump having a pump inlet fluidly coupled to the reservoir outlet and a pump outlet fluidly coupled to the first inlet, the fluid pump mounted on the body and operable to draw fluid from the fluid reservoir and direct the fluid into the first inlet, and
a second fluid conduit defined within the body and extending between the first fluid conduit and the return port of the fluid reservoir.

18. The differential assembly of claim 17 wherein the first outlet is defined on the inwardly-facing surface of the body and the plenum seals directly against the inwardly-facing surface.

19. The differential assembly of claim 17 further comprising:
a sealing member positioned between the inwardly-facing surface of the body and the plenum inlet.

20. The differential assembly of claim 17 further comprising at least one of a bleed orifice and a three-way valve positioned to limit fluid flow between the first fluid conduit and the second fluid conduit.
